(19) United States
(12) Patent Application Publication
(10) Pub. No.: US 2010/0019057 A1
(43) Pub. Date: Jan. 28, 2010

(54) DISPENSER OR DIFFUSER ASSEMBLY FOR DISPENSING OR DIFFUSING AT LEAST ONE COMPOSITION

(75) Inventors: Nicolas Duru, Paris (FR); Michel Fontaine, Paris (FR)

Correspondence Address: OLIFF & BERRIDGE, PLC, P.O. BOX 320850, ALEXANDRIA, VA, 22320-4850, US

(73) Assignee: L'OREAL, Paris (FR)

(21) Appl. No.: 12/438,459

(22) PCT Filed: Sep. 11, 2007
(86) PCT No.: PCT/IB2007/053661

§ 371 Date: Jun. 3, 2009

Related U.S. Application Data
(60) Provisional application No. 60/851,066, filed on Oct. 12, 2006.

(30) Foreign Application Priority Data
Sep. 12, 2006 (FR) 0653681
Feb. 19, 2007 (FR) 0753342

(51) Int. Cl. B05B 17/00; B05B 3/04

(52) U.S. Cl. 239/1; 239/102.2; 239/289

(57) ABSTRACT

The present invention relates to an assembly comprising: at least two independent refills, each comprising a reservoir containing a composition to be diffused or dispensed, and an electronic memory containing an audio and/or video file or a link that makes it possible to download such a file; and a dispenser or diffuser appliance for dispensing or diffusing a composition, said appliance being arranged to receive both refills simultaneously, to read the content of the electronic memory of at least one of the refills, and to diffuse or dispense the composition contained in said refill.

The present invention relates to dispensing or diffusing at least one composition contained in a refill, in particular a scented substance.

French patent application FR 2 795 348 discloses a programmable diffuser appliance for diffusing scented substances, and in which the refill can include an electronic chip containing specific information that is suitable for being read by a communication interface that is integrated in the appliance so as to make it possible for said appliance to recognize the refill.

U.S. Pat. No. 5,887,118 discloses an olfactory card for a personal computer, said card including a scented substance that is heat activated, and an electronic memory that is suitable for including graphical and/or audible information.

U.S. Pat. No. 6,654,664 describes a disk including a medium for heat-activated scents, and a space for recording multimedia data, such as an optical disk.

The invention seeks to improve still further dispenser or diffuser appliances for dispensing or diffusing at least one composition contained in a refill.

The appliances may be dispenser appliances for dispensing, in a solid or liquid form, at least one composition contained in the refill, e.g. a care product or makeup.

The appliances may also be diffuser appliances for diffusing, in the form of a spray and/or a gas, the composition, e.g. a scented substance, in particular a body spray or a room spray.

In one of its aspects, the invention provides an assembly (also called “kit”) comprising:
at least two independent refills, each comprising a reservoir containing a composition to be diffused or dispensed, and an electronic memory containing an audio and/or video file or a link that makes it possible to download such a file; and
a dispenser or diffuser appliance for dispensing or diffusing a composition, said appliance being arranged to receive both refills simultaneously, to read the content of the electronic memory of at least one of the refills, and to diffuse or dispense the composition contained in said refill.

Such an assembly makes it possible to dispense or diffuse a composition from amongst a plurality of compositions, by selecting a refill contained in the appliance.

Each refill may optionally include its own spray means, e.g. a piezoelectric transducer, an electrostatic spray system, an airbrush or a pressure-nozzle spray system. The dispenser or diffuser appliance may thus include a power supply for electrically powering the piezoelectric transducer or the electrostatic spray system and/or a pump that is used for spraying.

Alternatively, each refill need not include its own spray means, and in this event the dispenser or diffuser appliance includes at least one spray means that is associated with at least one refill, e.g. a piezoelectric, electrostatic, airbrush, or other spray system.

In another of its aspects, the invention also provides a refill for a dispenser or diffuser appliance for dispensing or diffusing at least one composition, the refill comprising:
at least one reservoir containing the composition to be dispensed or diffused; and
at least one electronic memory containing at least one audio and/or video file or a link that makes it possible to download such a file when the refill is placed in the dispenser or diffuser appliance for dispensing or diffusing the composition.

Such a refill may optionally include its own spray means, e.g. a piezoelectric transducer, an electrostatic spray system, or an airbrush spray system.

In an aspect of the invention relating more particularly to diffusing a substance, the refill can include a transporter element, in particular a wick, for transporting the composition by capillarity, said element being immersed in part in the composition.

The capillary transporter element facilitates the use of a spray system that includes a piezoelectric transducer, thereby enabling diffusion to be rapid and effective.

The use of an electronic memory makes it easy to miniaturize the refill and the appliance, and also makes it easy to read the information, and in combination with the use of a piezoelectric-transducer spray system, it can enable electricity consumption to be low, compatible with the refill being used in a hand-held appliance that can be carried easily.

The presence of a capillary transporter element also makes it possible to use a substance that is liquid, thereby making it easier to refill and/or recycle the refill, where appropriate.

The invention offers new possibilities for marketing a composition, making it possible to associate easily therewith at least one audio and/or video file or a link that makes it possible to download such a file.

This might involve a presentation film for presenting the composition, or images and sounds for creating a particular atmosphere to accompany the diffusion or the dispensing of the composition.

The invention can also make it possible to personalize the composition and/or the diffuser and/or dispenser appliance by associating therewith sounds and/or images that are selected by the user or by a friend or relative of said user, for example.

The term “video file” is used to cover not only a file containing only one non-animated image, but also a file containing a plurality of optionally-animated images. Where appropriate, the file can also contain audio data and other information that is associated with dispensing or diffusing the composition, for example.

By way of example, the video file format is *.arr, *.mpg, *.mov, *.esf, *.vmv, *.dvx, *.qt, *.avi or *.jpb, *.bmp, *.png, *.tif, *.ps, *.eps, inter alia.

By way of example, the audio file format is *.wav, *.mp3, *.ra, *.ram, *.aiff, *.en, *.mid, inter alia.

The memory may be the only electronic component in the refill, or, in a variant, one or more components useful for interfacing with the dispenser or diffuser appliance may also be included in the refill. The refill need not have a power supply.

The memory may contain at least one file in a format other than the formats mentioned above, e.g. containing information about actions to be performed by the appliance while the audio and/or video file is being read.

As mentioned above, the composition contained in the refill may be a cosmetic.

The composition may be a scented substance, in particular a body or room spray, the appliance being arranged to diffuse the substance.

The refill may include electrical contacts enabling the appliance to read data that is stored in the memory. By way of example, the contacts may be situated on an end face of the refill or elsewhere.

The memory may be a read-only memory, or it may be a read/write memory.

By way of example, the memory may be read automatically when the refill is put into place, when the appliance is turned on, when a member that controls dispensing is actuated, or in some other way, e.g. on an instruction input by the user into the appliance, or received from a remote-control or from a sensor or from any interface.

The size of the memory may be greater than or equal to 1 megabyte (MB), for example, and it may be less than or equal to 1 gigabyte (GB), for example.

Where appropriate, the memory may contain at least one item of information that controls automatic dispensing or diffusion of the composition while the audio and/or video file is being read. Where appropriate, dispensing or diffusion can thus take place at at least one predetermined moment while the audio and/or video file is being read.

The memory may also contain at least one parameter that is associated with dispensing the composition, the parameter relating, for example, to the amount of composition to be dispensed during an action of the user on the appliance, to information that is associated with the composition possibly being associated with other compositions, or to information that is associated with a time interval that ought to be allowed between two successive instants of dispensing the composition, so as to avoid olfactory saturation, for example.

The capacity of the reservoir may lie in the range 1 milliliter (mL) to 15 mL, for example, preferably 3 mL to 6 mL.

The refill may present an elongate shape or any other shape adapted to the appliance. The appliance may be portable and arranged to be hand-held, or it may be bigger in size.

The wick may have one end that is situated on a front face of the refill.

The appliance can be used at home, at work, in transport, in a beauty parlor, in a shop, in particular at a point of sale, or elsewhere.

The invention also relates to an assembly comprising:
a refill as defined above; and
a dispenser or diffuser appliance for dispensing or diffusing at least one composition contained in the refill, the appliance being arranged to receive the refill and to read, at least in part, the content of the electronic memory of the refill.

In particular, the appliance can be arranged to receive a plurality of refills.

In an aspect of the invention, the appliance is a diffuser appliance and includes a spray system including a piezoelectric transducer. The operation of the spray system may be controlled by data coming from the refill, where appropriate.

In another aspect of the invention, the refill includes a piezoelectric transducer, and the diffuser appliance includes a power supply and a control circuit for controlling the piezoelectric transducer.

Where appropriate, the appliance may include a screen that can be of any size.

Where appropriate, the appliance may include an interface that makes it possible to transmit data to a base station that is associated with the appliance, the station including, or being connected to, a screen and/or one or more loudspeakers.

In an embodiment of the invention, the appliance includes a connector enabling connection to the base station. The base station may be a personal digital assistant, a video and/or audio player, a mobile phone, a game console, a domestic appliance, a vehicle, a portion of a home systems network, a stereo system, a television or a computer, a digital photo frame, this list not being limiting.

Where appropriate, the dispenser or diffuser appliance may include a wireless interface that makes it possible to transmit data contained in the memory of the refill to the base station, e.g. video and/or audio data or a link that makes it possible to download such data.

The appliance may be arranged to receive a plurality of refills simultaneously, the refills containing different compositions, for example. Each of the refills may optionally include an electronic memory.

The appliance may be arranged to function only in the presence of a refill that includes a memory, after detecting its presence or the presence of specific data contained in said memory, e.g. an identifier. This makes it possible to avoid using unsuitable refills in the appliance.

In other aspects of the invention, the appliance may include other means for taking and dispensing or diffusing the composition contained in a refill, e.g. a suction pump that is actuated manually or electrically, or a compressor or a compressed-gas source, or a thermal system or an electrostatic system.

Where appropriate, the refill may include a pump for supplying composition to the dispenser or diffuser system that is present on the appliance or on the refill, the pump being suitable for being mechanically driven by the dispenser or diffuser appliance, where appropriate.

The appliance may include selector means for selecting at least one composition to be dispensed or diffused when said appliance receives a plurality of compositions, and/or when a refill includes a plurality of compositions.

The selector means may comprise a member that can be operated by the user, e.g. so as to select an item of data displayed on the screen of the appliance when such a screen is present, or on an associated screen.

The selector means may comprise a touch-sensitive screen or any other user interface.

The appliance may include at least one pushbutton for triggering the dispensing or diffusion of the composition thus selected or the single composition present in the refill, where appropriate.

In another of its aspects, the invention also provides a dispenser or diffuser appliance for dispensing or diffusing at least one composition, the appliance being arranged to receive at least two refills simultaneously, the refills being independent, and each comprising a reservoir containing a composition to be diffused or dispensed, and an electronic memory containing an audio and/or video file or a link that makes it possible to download such a file, the appliance being arranged to read the content of the memory of each refill, and to diffuse or dispense the composition contained in said refill.

Where appropriate, the appliance may be arranged to display images and/or to reproduce sounds coming from the memory, and to make it possible to select the composition to be diffused or dispensed.

The invention also relates to a method of programming a refill as defined above, the method comprising the step consisting in loading into the electronic memory of the refill, at least one audio and/or video file and/or a link that makes it possible to download such a file.

Programming can be performed by placing the refill in a suitable terminal, e.g. at a point of sale, at home, at a shipping location, or in the factory.

In a variant, programming can be performed with the dispenser or diffuser appliance itself, said appliance including a connector or an interface that makes it possible to receive data for storing in the memory, for example.

By way of example, the appliance can include a location for receiving a memory card from a camera, a video camera, or a camera phone, or for receiving a connector that makes it possible to connect a cable that is connected to such a data source.

The appliance can also include a radio or infra-red interface, e.g. of Blue Tooth®, wi-fi, or similar type, for receiving data for storing in the refill.

The invention also provides a method of dispensing or diffusing a composition from a refill as defined above that is inserted in an associated dispenser or diffuser appliance, the method comprising the steps consisting in:
reading, at least in part, an audio and/or video file contained in the electronic memory of the refill, or a link that makes it possible to download such a file;
reproducing images and/or sounds from the file; and
dispensing and/or diffusing a composition before, after, or during the reproduction of the images or sounds.

By way of example, the method is implemented with a refill including a piezoelectric transducer for spraying the composition, or with a refill including a capillary transporter element that makes it possible to feed composition to a transducer that does not belong to the refill.

The invention also provides a refill comprising:
a reservoir containing a composition to be diffused or dispensed;
a piezoelectric transducer;
a memory containing an audio and/or video file or a link that makes it possible to download such a file; and
electrical contacts for co-operating with corresponding contacts of a diffuser or dispenser appliance in which the refill is disposed.

The invention also provides a refill comprising:
a reservoir containing a composition to be diffused or dispensed;
a spray system, e.g. a piezoelectric, electrostatic, or airbrush spray system;
a memory containing an audio and/or video file or a link that makes it possible to download such a file; and
electrical contacts for co-operating with corresponding contacts of a diffuser or dispenser appliance in which the refill is disposed.

The invention can be better understood on reading the following detailed description of non-limiting embodiments thereof, and on examining the accompanying drawings, in which:

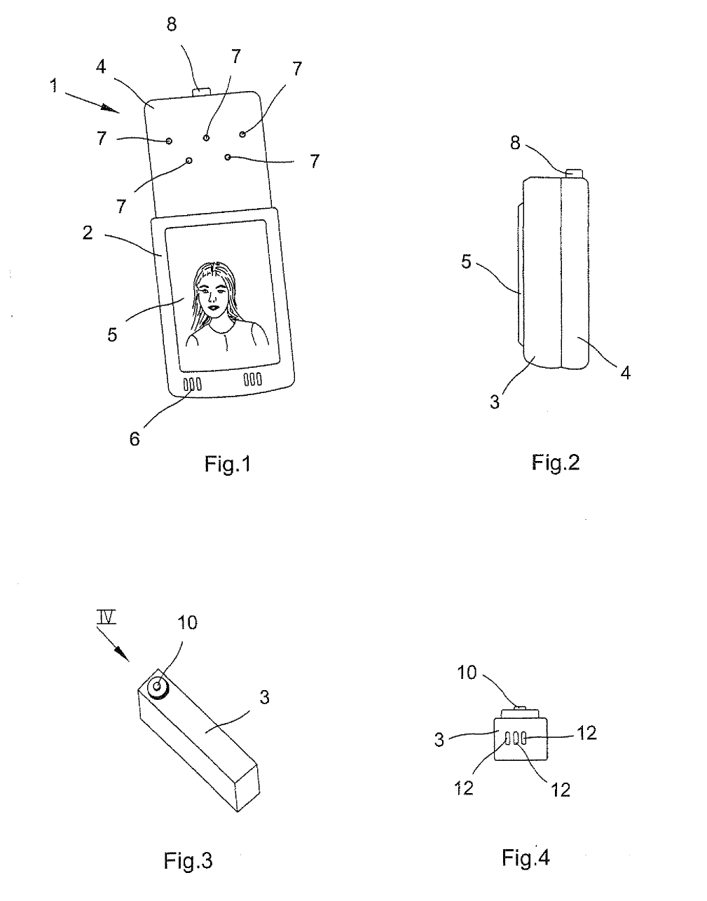

FIG. 1 is a diagrammatic elevation view of an embodiment of a diffuser appliance for diffusing a scented substance, constituting an embodiment of the invention, and shown in the open position;

FIG. 2 is a side view of the FIG. 1 appliance, in its closed position;

FIG. 3 is a diagrammatic and perspective view of an embodiment of a refill for the appliance in FIGS. 1 and 2;

FIG. 4 is a plan view as seen looking along arrow IV in FIG. 3;

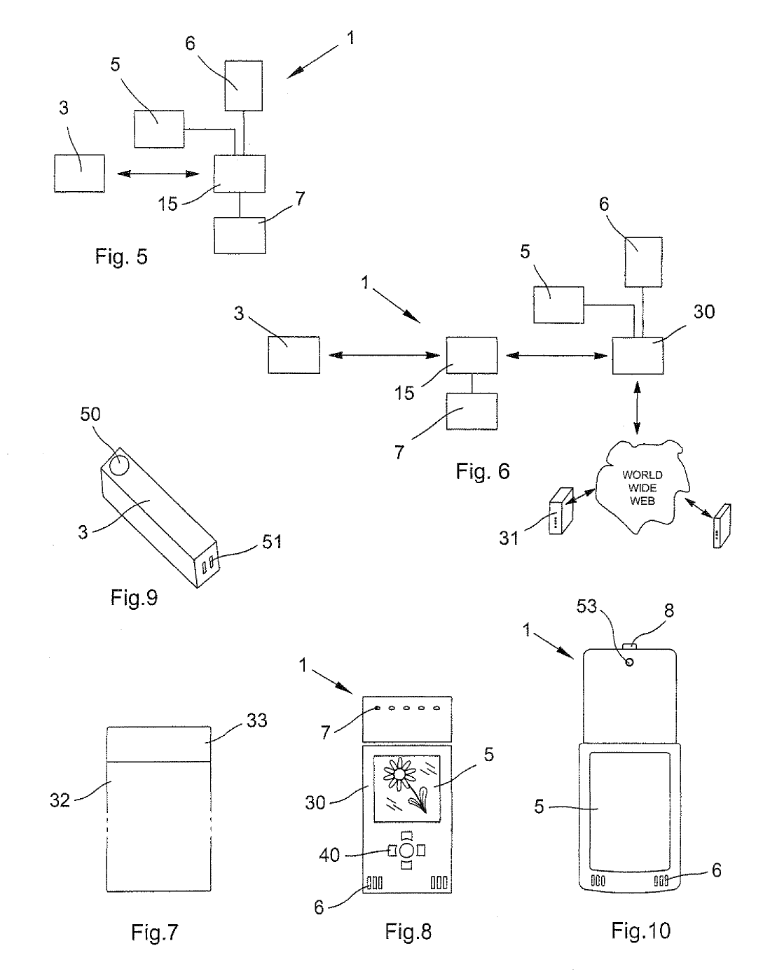

FIGS. 5 and 6 are diagrams of examples of set-ups constituting embodiments of the invention;

FIG. 7 is an embodiment of a file that is suitable for being stored in the memory of the refill;

FIG. 8 shows a variant embodiment of the diffuser appliance;

FIG. 9 is a diagrammatic view of a variant embodiment of the refill; and

FIG. 10 is a diagrammatic view of a variant embodiment of the appliance.

The diffuser appliance 1 shown in FIG. 1 comprises a casing 2 that is suitable for containing at least one refill of at least one composition to be diffused, the refill being the refill shown in FIG. 3, for example.

In the embodiment shown, the casing 2 comprises a front portion 3 and a rear portion 4 that is movable relative to the front portion between an open position shown in FIG. 1 and a closed position shown in FIG. 2.

The rear portion 4 can be displaced relative to the front portion 2 by sliding and/or turning, for example, and it can automatically switch the appliance on or off, for example.

In the embodiment shown the front portion 3 includes a screen 5 and at least one loudspeaker 6. In an embodiment of the invention, the rear portion 4 includes one or more spray systems 7 for spraying the composition contained in the refill. In a variant embodiment of the invention, the rear portion 4 includes at least one opening enabling the composition diffused by a refill to be delivered.

In the embodiment under consideration, the appliance 1 can receive a plurality of refills disposed side by side, so as to make it possible to diffuse a scented substance selected from a plurality of scented substances, as a function of user selection, for example.

Each spray system 7 can be associated with a refill and can comprise a piezoelectric transducer that is arranged to diffuse the composition in the form of fine droplets by means of a perforated membrane that is caused to vibrate.

In the embodiment shown, the spray orifice becomes visible when the appliance is in its open position, and it is closed in leaktight manner when the appliance is in its closed position, for example.

The appliance 1 can include a control button 8 that, when actuated by the user, causes a selected composition to be diffused.

By way of example, selection can be made by means of the screen 5, which can be a touch-sensitive screen, or by means of at least one navigator or selector button, or by means of any other user interface, e.g. a voice interface, a remote control, a keypad, a mouse, a scroll wheel, or a cursor, this list not being limiting.

In the embodiment shown, the appliance 1 is arranged to be hand-held, e.g. being more or less the size of a mobile telephone, but in a variant not shown, the appliance 1 can be larger in size in order to be placed on a piece of furniture, for example.

Where appropriate, the appliance 1 can also include a screen that is relatively large in size, and it can be equipped with an analog and/or digital tuner and/or with a radio communications module, e.g. GSM, wi-fi, or other, and/or with at least one reader and/or writer of a medium such as an optical disk, a memory card, a magnetic strip, or a hard disk, for example.

With reference to FIG. 3, it can be seen that the refill 3 shown in the figure comprises a reservoir containing the composition to be diffused, within which there is dipped a capillary transporter element, in this event a wick, having one end 10 that is arranged to come into contact with the associated spray system in the appliance 1. The wick can be made out of any material that makes it possible to transfer composition by capillarity. Only part of the wick is immersed in the liquid composition, the end 10 being situated outside the reservoir.

According to an aspect of the invention, the refill 3 incorporates an electronic memory not shown in the figure, e.g. a static or dynamic memory (SRAM or DRAM), e.g. RDRAM, DDR SDRAM, MRAM, DDR2-SDRAM, XDRRAM, or a flash memory, e.g. NVRAM.

The refill can include electrical contacts 12 that make contact with corresponding contacts that are provided in the appliance 1, in such a manner as to enable said appliance to read the memory and to write to said memory where appropriate.

In a variant, the refill 3 is arranged for remotely exchanging information with the appliance 1, e.g. by means of an RFID chip that can optionally contain the electronic memory, or by means of a radio or infrared interface.

The refill 3 need not have a power supply. In a variant, the refill 3 can incorporate a power supply.

In the variant shown in FIG. 9, in addition to the reservoir containing the composition to be diffused and the electronic memory, the refill includes a piezoelectric transducer 50 and electrical contacts 51 enabling the appliance 1 to control its operation.

In the variant shown in FIG. 10, the appliance 1 includes a main housing for receiving an active refill, and at least one auxiliary housing for receiving a non-active refill.

The user can decide which refill to place in the main housing.

The appliance 1 can be arranged to read the content of the memory of the refill contained in at least the main housing, and possibly also to read the memory of the refill(s) contained in the auxiliary housing(s).

The appliance 1 can be equipped with a spray system that is associated with the sole refill contained in the main housing. In a variant, in which the refill includes its own spray means, the appliance 1 can, as shown, include an opening 53 for delivering the composition diffused by the refill.

Regardless of whether or not the refill includes its own dispenser or diffuser means, and as shown in FIG. 5, the appliance 1 can include a processor unit 15 comprising one or more microprocessors or microcontrollers and possible peripheral circuits, for example, and which, in the embodiments in FIGS. 1, 2, and 10 displays images on the screen 5 and reproduces sounds via the loudspeaker(s) 6.

Regardless of whether or not it is completely integrated in the appliance 1, the spray system can also be controlled by the processor unit 15.

In the variant shown in FIG. 6, the appliance 1 includes neither a screen nor a loudspeaker, and it communicates via an optionally-wired connection with a base station 30 that can include, or be connected in optionally-wired manner to, a screen and one or more loudspeakers 6.

Where appropriate, the base station 30 can communicate with at least one remote server 31 via a computer network, in particular the Internet.

The content of the electronic memory of the refill 3 can be used in various ways.

In a first embodiment of the invention, putting the refill into place in the appliance automatically gives the user the option of reading audio and/or video information contained in said refill. The user can decide whether or not to spray the composition, and, where appropriate, can select the composition to be sprayed from amongst a plurality of compositions.

In another embodiment of the invention and as shown in FIG. 7, the memory can contain a file comprising a video sequence 32 and information 33 such as time codes relating to the operation of one or more spray systems at predefined instants in the sequence 32. Thus, while the sequence 32 is being viewed, the appliance 1 can, in association with certain images in the sequence, automatically diffuse one or more scented substances in order to recreate an olfactory atmosphere corresponding to the images being reproduced, for example.

The appliance 1 can also be intended to operate in physical association with the base station 30, as shown in FIG. 8.

By way of example, the base station 30 is thus in the form of an MP3 player, or a personal digital assistant, a mobile phone, a digital photo frame, a monitor or television set, or a specific accessory.

In the embodiment in FIG. 8, the appliance 1 can be fastened on the base station 30 in order to benefit from the power supply of said base station, and from its screen 5 and loudspeakers 6, if any, and from the user interface 40. Information can be exchanged with the base station 30 by means of an electrical connector that is present on said base station.

In a variant, the electronic memory of the refill contains no more than a link, e.g. an Internet address, enabling the appliance 1 or the base station 30 to connect to the server 31 in order to recover one or more audio and/or video files for reading.

By way of example, the refill can include an address that enables the base station to recover an advertising film relating to the composition, or, in a variant, a message from a friend or relative who has given the composition as a gift.

The electronic memory of the refill can contain various audio and/or video contents.

By way of example, the electronic memory can contain an advertising film for displaying on the diffuser or dispenser appliance to warn the user or the consumer of one or more characteristics of the composition.

The electronic memory can also contain images or sounds for creating a particular atmosphere while the appliance 1 is being used.

By way of example, the video sequence can comprise footage about the creator of the olfactory atmosphere, or images showing the places or plants that are associated with the scent, e.g. images of the plant having the scent that is present, or seaside images for a marine olfactory atmosphere.

The electronic memory can also contain images or sounds that the user would like to see or hear while using the appliance 1, e.g. photographs of friends or relatives or of landscapes. The user may have transmitted images and/or sounds for downloading into the memory to a server from a remote site.

The base station 30 can also be a computer, and the appliance 1 can be in the form of a USB key or any other peripheral that is capable of benefiting from the power supply of the computer, for example.

The base station 30 can also be in the form of a GPS navigator inside a motor vehicle, or it can be integrated in the dashboard, and the appliance can be for creating a particular olfactory atmosphere inside the vehicle.

The appliance 1 can also be in the form of a frame that makes it possible to display an image or a slide show by means of information contained in the memory of the refill.

Dispensing and diffusing the composition can be controlled by an action of the user, or by information contained in the audio and/or video file as read, or can even result from the detection of an event by a sensor, e.g. a presence sensor, which could be included in the appliance.

Thus, for example, when a person enters a room in which the appliance is situated, said appliance can trigger the dispensing or diffusion of some composition and can perhaps also trigger the reproduction of images and/or sounds, so as to create a particular atmosphere in the room, for example.

The refill can present shapes other than the shape shown, e.g. a disk, a bottle, or a flexible or rigid pre-impregnated flexible medium, with the substance being diffused for example by spraying or by evaporating, e.g. by means of a thermal system. Where appropriate, the refill can include at least one reservoir that is removable or that can be refilled by means of a valve or a suitable stopper member, making it possible for the refill to benefit from a new quantity of composition to be dispensed or diffused, while preserving its electronic memory.

The dispenser and spray appliance can be provided to be placed on a stand in order to recharge a power supply present therein. The appliance can be removed from its stand in order to be taken away by the user, e.g. in a pocket or in a bag, then replaced on the stand when the user returns.

The dispenser or diffuser appliance can also include a solar panel for recharging a battery.

Independently or in combination with the above, the invention also provides a dispenser or diffuser appliance for dispensing or diffusing at least one composition contained in a refill, the appliance including: a screen on which there can be displayed at least one item of information that is associated with a composition to be sprayed; and a control member that makes it possible to select said information.

Independently or in combination with the above, the invention also provides a dispenser or diffuser appliance for dispensing or diffusing at least one composition, the appliance comprising a front portion and a rear portion that are movable relative to each other between a closed position and an open position that uncovers at least one diffuser orifice for diffusing the composition from a piezoelectric-transducer spray system.

Naturally, the invention is not limited to the embodiments described above and the characteristics of those embodiments can be combined together within variants not shown.

By way of example, the dispenser or diffuser appliance could include only one spray system for operating with a single refill.

The expression “comprising a” should be understood as being synonymous with the expression “comprising at least one” unless specified to the contrary.

1-35. (canceled)

36. An assembly comprising:
at least two independent refills, each comprising a reservoir containing a composition to be diffused or dispensed, and an electronic memory containing information related to an audio and/or video file or enabling downloading of such a file; and
a dispenser or diffuser appliance for dispensing or diffusing a composition, said appliance being configured to contain both refills simultaneously, to read the information of the electronic memory of at least one of the two independent refills, and to diffuse or dispense the composition contained in the at least one refill.

37. An assembly according to claim 36, the at least one refill including a piezoelectric transducer for spraying the composition to be diffused or dispensed.

38. An assembly according to claim 37, the appliance including a power supply for electrically powering the piezoelectric transducer.

39. An assembly according to claim 36, the at least one refill comprising:
a transporter element for transporting the composition by capillarity.

40. An assembly according to claim 36, at least one composition contained in the at least one refill being a cosmetic.

41. An assembly according to claim 36, at least one composition contained in the at least one refill being a scented substance, the appliance being arranged to diffuse the substance.

42. An assembly according to claim 36, at least one of the two independent refills including electrical contacts enabling the appliance to read data that is stored in the electronic memory.

43. An assembly according to claim 42, each refill including electrical contacts enabling the appliance to read data that is stored in the electronic memory.

44. An assembly according to claim 42, the contacts being situated on an end face of the refill.

45. An assembly according to claim 36, the electronic memory being a read-only memory.

46. An assembly according to claim 36, the electronic memory being a read/write memory.

47. An assembly according to claim 36, a size of the electronic memory being greater than or equal to 1 MB.

48. An assembly according to claim 36, a size of the electronic memory being less than or equal to 1 GB.

49. An assembly according to claim 36, the electronic memory containing at least one item of information that controls automatic dispensing or diffusion of the composition while the audio and/or video file is being read.

50. An assembly according to claim 36, the electronic memory containing at least one parameter that is associated with dispensing the composition.

51. An assembly according to claim 50, the parameter relating to an amount of composition to be dispensed during an action of a user on the dispenser or diffuser appliance.

52. An assembly according to claim 50, the parameter relating to the composition being associated with other compositions.

53. An assembly according to claim 50, the parameter relating to a time interval between two successive periods of dispensing the composition.

54. An assembly according to claim 36, the capacity of the reservoir lying in the range 1 mL to 15 mL.

55. An assembly according to claim 36, at least one of the two independent refills presenting an elongate shape.

56. An assembly according to claim 39, the transporter element having one end that is situated on a front face of the refill.

57. An assembly according to claim 36, the dispenser or diffuser appliance including a spray system including a piezoelectric transducer.

58. An assembly according to claim 36, the dispenser or diffuser appliance including a display.

59. An assembly according to claim 36, the dispenser or diffuser appliance including an interface enabling transmission of data to a base station that is associated with the dispenser or diffuser appliance, the base station including, or being connected to, a display and/or at least one loudspeaker.

60. An assembly according to claim 59, the dispenser or diffuser appliance including a connector enabling connection to the base station.

61. An assembly according to claim 59, the dispenser or diffuser appliance including a wireless interface enabling transmission of data to the base station.

62. An assembly according to claim 36, the dispenser or diffuser appliance including a selector for selecting a composition contained in a refill.

63. An assembly according to claim 62, the selector comprising a member that can be operated by a user so as to select an item of data displayed on a display of the dispenser or diffuser appliance or on an associated display.

64. An assembly according to claim 62, the selector comprising a touch-sensitive display.

65. An assembly according to claim 36, the dispenser or diffuser appliance including at least one pushbutton for triggering dispensing or diffusion of the composition.

66. A method of programming a refill of an assembly as defined in claim 36, the method comprising loading into the electronic memory of the refill, at least one audio and/or video file and/or a link enabling downloading of such a file.

67. A method of dispensing or diffusing a composition from a refill of an assembly as defined in claim 36, the refill being inserted in an associated dispenser or diffuser appliance, and the method comprising:
reading, at least in part, an audio and/or video file contained in the electronic memory of the refill, or a link that enables downloading of such a file;
reproducing images and/or sounds from the file; and
diffusing the composition contained in the refill before, after, or during the reproduction of the images or sounds.

68. A dispenser or diffuser appliance for dispensing or diffusing a composition, the appliance being configured to contain at least two refills simultaneously, the at least two refills being independent, and each of the at least two refills comprising a reservoir containing a composition to be diffused or dispensed, and an electronic memory containing an audio and/or video file or a link enabling downloading of such a file, the appliance being configured to read the memory of each refill, and to diffuse or dispense the composition contained in said each refill.

69. An appliance according to claim 68, the dispenser or diffuser appliance including electrical power contacts for electrically powering a piezoelectric transducer that is integrated in the refill.

70. An appliance according to claim 68, the dispenser or diffuser appliance being configured to display images and/or to reproduce sounds coming from the electronic memory, and to enable a selection of the substance to be diffused or dispensed.

71. A refill comprising:
a reservoir containing a composition to be diffused or dispensed;
a piezoelectric transducer;
a memory containing an audio and/or video file or a link enabling downloading of such a file; and
electrical contacts for co-operating with corresponding contacts of a diffuser or dispenser appliance in which the refill is disposed.
